(19) United States
(12) Patent Application Publication
(10) Pub. No.: US 2021/0208374 A1
(43) Pub. Date: Jul. 8, 2021

(54) OPTICAL SYSTEM, OPTICAL APPARATUS, AND METHOD FOR MANUFACTURING THE OPTICAL SYSTEM

(71) Applicant: Nikon Corporation, Minato-ku, Tokyo (JP)

(72) Inventor: Tomonori KURIBAYASHI, Yokohama-shi (JP)

(21) Appl. No.: 17/059,455

(22) PCT Filed: May 28, 2018
(86) PCT No.: PCT/JP2018/020401

§ 371 Date: Nov. 29, 2020

(51) Int. Cl. G02B 15/20; G02B 5/00; G02B 7/04

(52) U.S. Cl. CPC G02B 15/20; G02B 7/04; G02B 5/005

(57) ABSTRACT

An optical system comprises a lens satisfying the following conditional expressions.

2.0100<ndLZ+(0.00925×νdLZ)<2.0800

28.0<νdLZ<40.0
where, ndLZ: a refractive index of the lens relative to a d-line
   νdLZ: a d-line based Abbe number of the lens.

### TECHNICAL FIELD

The present invention relates to an optical system, an optical apparatus, and a manufacturing method of the optical system.

### TECHNICAL BACKGROUND

Imaging devices used in imaging units such as a digital camera and a video camera have recently been increasingly improved in the number of pixels. A photographic lens mounted on an imaging unit comprising such an imaging device is desired to be a lens exhibiting a high resolution with, in addition to reference aberrations (single-wavelength aberrations) such as a spherical aberration and a coma aberration, a chromatic aberration successfully corrected to prevent the color of an image under a white light source from blurring. In particular, it is desirable that a secondary spectrum be successfully corrected in addition to primary achromatization during the chromatic aberration correction. For example, a method using a resin material with anomalous dispersion characteristics (see, for example, Patent literature 1) has been known as a technique for chromatic aberration correction. Accordingly, a photographic lens with various aberrations successfully corrected is desired due to a recent improvement in the number of pixels in imaging devices.

### PRIOR ARTS LIST

### Patent Document

Patent literature 1: Japanese Laid-Open Patent Publication No. 2016-194609(A)

### SUMMARY OF THE INVENTION

An optical system according to a first aspect comprises a lens satisfying the following conditional expressions,

2.0100<ndLZ+(0.00925×νdLZ)<2.0800

28.0<νdLZ<40.0

where, ndLZ: a refractive index of the lens relative to a d-line

νdLZ: a d-line based Abbe number of the lens.

An optical system according to a second aspect comprises a lens satisfying the following conditional expressions,

1.8500<ndLZ+(0.00495×νdLZ)<1.9200

28.0<νdLZ<40.0

where, ndLZ: a refractive index of the lens relative to a d-line

νdLZ: a d-line based Abbe number of the lens.

An optical apparatus according to a third aspect comprises the optical system according to the first or second aspect.

A manufacturing method of an optical system according to a fourth aspect, which is a manufacturing method of an optical system including a lens, comprises disposing the lens within a lens barrel such that the following conditional expressions are satisfied,

2.0100<ndLZ+(0.00925×νdLZ)<2.0800

28.0<νdLZ<40.0

where, ndLZ: a refractive index of the lens relative to a d-line

νdLZ: a d-line based Abbe number of the lens.

A manufacturing method of an optical system according to a fifth aspect, which is a manufacturing method of an optical system including a lens, comprises disposing the lens within a lens barrel such that the following conditional expressions are satisfied,

1.8500<ndLZ+(0.00495×νdLZ)<1.9200

28.0<νdLZ<40.0

where, ndLZ: a refractive index of the lens relative to a d-line

νdLZ: a d-line based Abbe number of the lens.

### BRIEF DESCRIPTION OF THE DRAWINGS

FIG. 1 shows a lens configuration of an optical system according to Example 1 upon focusing on infinity;

FIG. 2A is graphs showing various aberrations of the optical system according to Example 1 upon focusing on infinity and FIG. 2B is graphs showing various aberrations of the optical system according to Example 1 upon focusing on a short-distance object;

FIG. 3 shows a lens configuration of an optical system according to Example 2 upon focusing on infinity;

FIG. 4A is graphs showing various aberrations of the optical system according to Example 2 upon focusing on infinity and FIG. 4B is graphs showing various aberrations of the optical system according to Example 2 upon focusing on a short-distance object;

FIG. 5 shows a lens configuration of an optical system according to Example 3 upon focusing on infinity;

FIG. 6A, FIG. 6B, and FIG. 6C are graphs showing various aberrations of the optical system according to Example 3 upon focusing on infinity in a wide-angle end state, an intermediate focal length state, and a telephoto end state, respectively;

FIG. 7A, FIG. 7B, and FIG. 7C are graphs showing various aberrations of the optical system according to Example 3 upon focusing on a short-distance object in the wide-angle end state, the intermediate focal length state, and the telephoto end state, respectively;

FIG. 8 shows a lens configuration of an optical system according to Example 4 upon focusing on infinity;

FIG. 9A, FIG. 9B, and FIG. 9C are graphs showing various aberrations of the optical system according to Example 4 upon focusing on infinity in the wide-angle end state, the intermediate focal length state, and the telephoto end state, respectively;

FIG. 10A, FIG. 10B, and FIG. 10C are graphs showing various aberrations of the optical system according to Example 4 upon focusing on a short-distance object in the wide-angle end state, the intermediate focal length state, and the telephoto end state, respectively;

FIG. 11 shows a configuration of a camera comprising the optical system according to the present embodiment; and

FIG. 12 is a flowchart showing a manufacturing method of the optical system according to the present embodiment.

### DESCRIPTION OF THE EMBODIMENTS

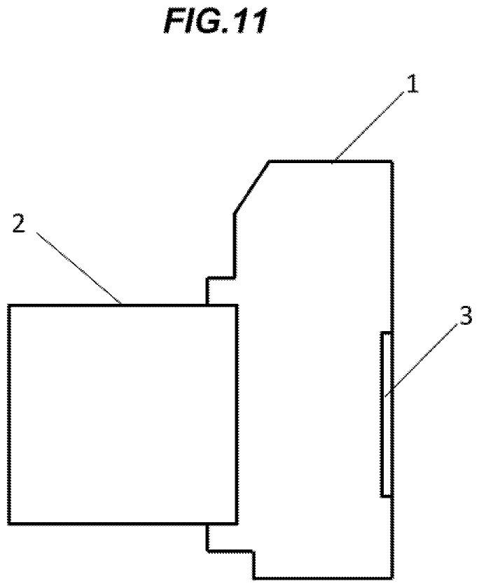

Description will be made below on optical systems and optical apparatuses according to Embodiment 1 and Embodiment 2 with reference to the drawings. First, description will be made on a camera (optical apparatus) comprising one of the optical systems according to of Embodiment 1 and Embodiment 2 with reference to FIG. 11. A camera 1 is a digital camera comprising an optical system according to the present embodiment as a photographic lens 2 as shown in FIG. 11. In the camera 1, light from an unshown object (subject) is collected through the photographic lens 2, reaching an imaging device 3. The light from the subject is thus formed into an image by the imaging device 3 and recorded as an image of the subject in an unshown memory. A photographer can capture an image of the subject with the camera 1 in such a manner. It should be noted that the camera may be a mirrorless camera or a single-lens reflex camera with a quick return mirror.

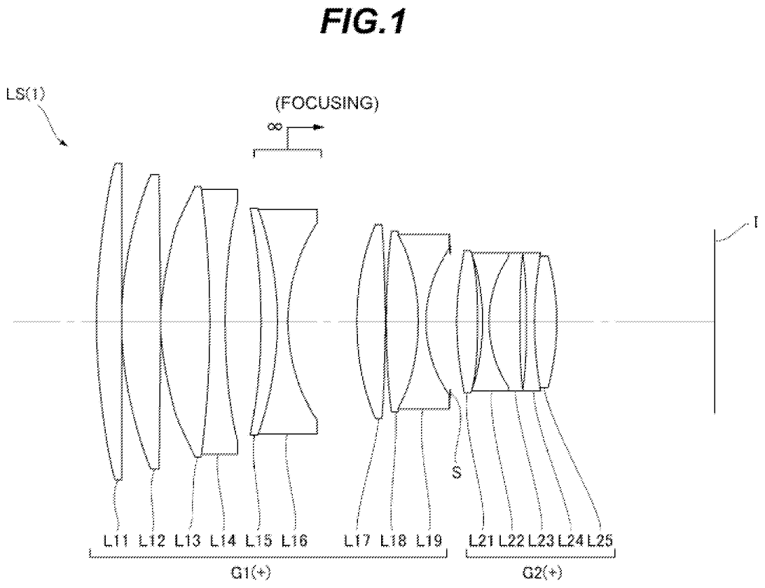

Next, description will be made on Embodiment 1 of the optical system (photographic lens). It is desirable that an example of an optical system LS according to Embodiment 1, namely, an optical system LS(1), comprise a lens (L22) satisfying the following conditional expression (1) and conditional expression (2) as shown in FIG. 1. In Embodiment 1, the lens satisfying the conditional expression (1) and the conditional expression (2) is occasionally referred to as a specific lens for the purpose of distinguishing from another lens.

2.0100<ndLZ+(0.00925×νdLZ)<2.0800 (1)

28.0<νdLZ<40.0 (2)

where, ndLZ: the refractive index of the specific lens relative to a d-line

νdLZ: the d-line based Abbe number of the specific lens

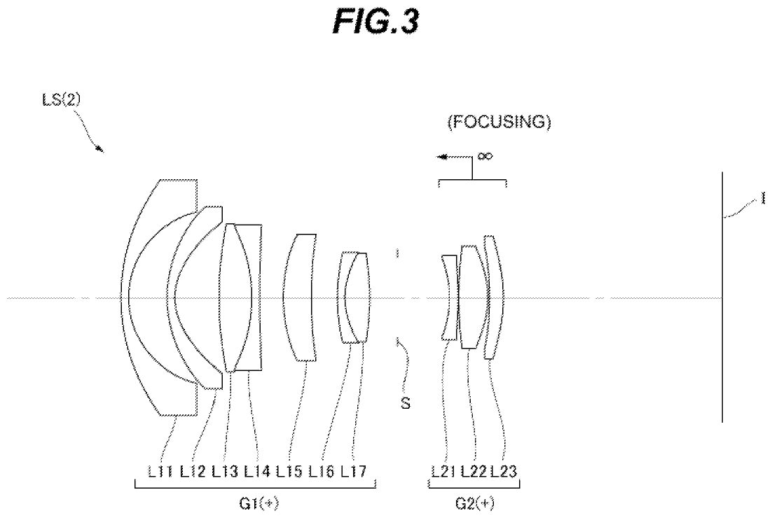

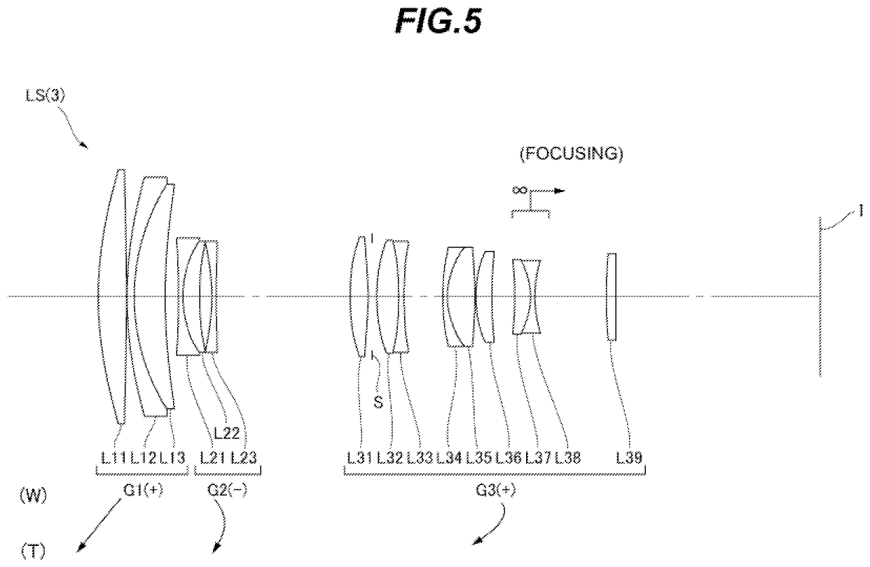

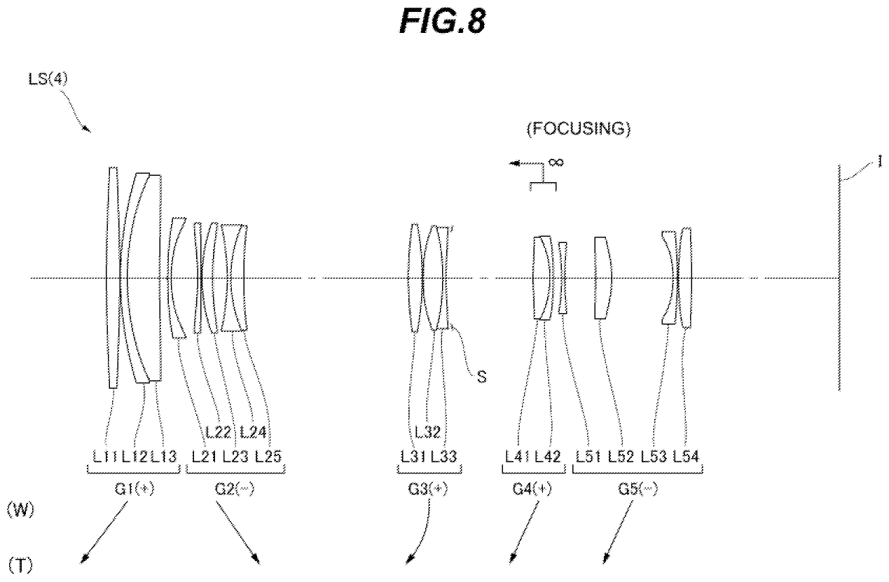

According to Embodiment 1, it is possible to provide an optical system with a secondary spectrum successfully corrected in addition to primary achromatization during chromatic aberration correction and an optical apparatus comprising the optical system. The optical system LS according to Embodiment 1 may be an optical system LS(2) shown in FIG. 3, an optical system LS(3) shown in FIG. 5, or an optical system LS(4) shown in FIG. 8.

The conditional expression (1) defines an appropriate relation between the refractive index of a material of the specific lens and the Abbe number. With the conditional expression (1) satisfied, correction of reference aberrations such as a spherical aberration and a coma aberration and correction of a primary chromatic aberration (achromatization) can be successfully performed.

An increase in the corresponding value of the conditional expression (1) above the upper limit is not preferable, since it makes the curvature of field difficult to correct due to, for example, a reduction in the Petzval sum. Setting the upper limit of the conditional expression (1) at 2.0775 can make the effects of the present embodiment more achievable. To make the effects of the present embodiment further achievable, the upper limit of the conditional expression (1) may be set at 2.0750, 2.0725, 2.0700, or even 2.0680.

A decrease in the corresponding value of the conditional expression (1) below the lower limit is not preferable, since it makes correction of various aberrations including an longitudinal chromatic aberration difficult. Setting the lower limit of the conditional expression (1) at 2.0150 can make the effects of the present embodiment more achievable. To make the effects of the present embodiment further achievable, the lower limit of the conditional expression (1) may be set at 2.0200, 2.0255, or even 2.0300.

The conditional expression (2) defines an appropriate range of the Abbe number of the specific lens. With the conditional expression (2) satisfied, correction of the reference aberrations such as the spherical aberration and the coma aberration and the correction of a primary chromatic aberration (achromatization) can be successfully performed.

An increase in the corresponding value of the conditional expression (2) above the upper limit is not preferable, since it makes, for example, correction of an longitudinal chromatic aberration difficult in a partial group on an object side or an image side relative to an aperture stop S. Setting the upper limit of the conditional expression (2) at 39.5 can make the effects of the present embodiment more achievable. To make the effects of the present embodiment further achievable, the upper limit of the conditional expression (2) may be set at 39.0 or even 38.5.

A decrease in the corresponding value of the conditional expression (2) below the lower limit is not preferable, since it makes, for example, correction of various aberrations including an longitudinal chromatic aberration difficult. Setting the lower limit of the conditional expression (2) at 28.5 can make the effects of the present embodiment more achievable. To make the effects of the present embodiment further achievable, the lower limit of the conditional expression (2) may be set at 29.0 or even 29.5.

In the optical system of Embodiment 1, it is desirable that the specific lens satisfy the following conditional expression (3).

θgFLZ+(0.00316×νdLZ)<0.7010 (3)

where, θgFLZ: the partial dispersion ratio of the specific lens, being defined by the following expression when the refractive index of the specific lens relative to a g-line is denoted by ngLZ, the refractive index of the specific lens relative to an F-line is denoted by nFLZ, and the refractive index of the specific lens relative to a C-line is denoted by nCLZ.

θgFLZ=(ngLZ−nFLZ)/(nFLZ−nCLZ)

It should be noted that the d-line based Abbe number νdLZ of the specific lens is defined by the following expression.

νdLZ=(ndLZ−1)/(nFLZ−nCLZ)

The conditional expression (3) appropriately defines the anomalous dispersion characteristics of the specific lens. With the conditional expression (3) satisfied, the secondary spectrum can be successfully corrected in addition to primary achromatization during chromatic aberration correction.

An increase in the corresponding value of the conditional expression (3) above the upper limit results in an increase in the anomalous dispersion characteristics of the specific lens, making chromatic aberration correction difficult. Setting the upper limit of the conditional expression (3) at 0.7000 can make the effects of the present embodiment more achievable. To make the effects of the present embodiment further achievable, the upper limit of the conditional expression (3) may be set at 0.6990, 0.6985, 0.6980, or even 0.6975.

In the optical system of Embodiment 1, the specific lens may satisfy the following conditional expression (2-1).

35.0<νdLZ<40.0 (2-1)

The conditional expression (2-1) is similar to the conditional expression (2). With the conditional expression (2-1) satisfied, correction of reference aberrations such as a spherical aberration and a coma aberration and correction of a primary chromatic aberration (achromatization) can be successfully performed. Setting the upper limit of the conditional expression (2-1) at 39.5 can make the effects of the present embodiment more achievable. To make the effects of the present embodiment further achievable, the upper limit of the conditional expression (2-1) may be set at 39.0, 38.5, or even 38.0. Meanwhile, setting the lower limit of the conditional expression (2-1) at 35.3 can make the effects of the present embodiment more achievable. To make the effects of the present embodiment further achievable, the lower limit of the conditional expression (2-1) may be set at 35.5, 35.8, or even 36.0.

In the optical system of Embodiment 1, it is desirable that the specific lens satisfy the following conditional expression (4).

1.660<ndLZ<1.750 (4)

The conditional expression (4) defines an appropriate range of the refractive index of the specific lens. With the conditional expression (4) satisfied, various aberrations such as a coma aberration and a chromatic aberration (an longitudinal chromatic aberration and a chromatic aberration of magnification) can be successfully corrected.

An increase in the corresponding value of the conditional expression (4) above the upper limit is not preferable, since it makes various aberrations such as a coma aberration and a chromatic aberration (an longitudinal chromatic aberration and a chromatic aberration of magnification) difficult to correct. Setting the upper limit of the conditional expression (4) at 1.745 can make the effects of the present embodiment more achievable. To make the effects of the present embodiment further achievable, the upper limit of the conditional expression (4) may be set at 1.740 or even 1.735.

A decrease in the corresponding value of the conditional expression (4) below the lower limit is not preferable either, since it makes various aberrations such as a coma aberration and a chromatic aberration (an longitudinal chromatic aberration and a chromatic aberration of magnification) difficult to correct. Setting the lower limit of the conditional expression (4) at 1.662 can make the effects of the present embodiment more achievable. To make the effects of the present embodiment further achievable, the lower limit of the conditional expression (4) may be set at 1.664 or even 1.666.

In the optical system of Embodiment 1, the specific lens may satisfy the following conditional expression (4-1).

1.670<ndLZ<1.710 (4-1)

The conditional expression (4-1) is similar to the conditional expression (4). With the conditional expression (4-1) satisfied, various aberrations such as a coma aberration and a chromatic aberration (an longitudinal chromatic aberration and a chromatic aberration of magnification) can be successfully corrected. Setting the upper limit of the conditional expression (4-1) at 1.708 can make the effects of the present embodiment more achievable. To make the effects of the present embodiment further achievable, the upper limit of the conditional expression (4-1) may be set at 1.705, 1.703, or even 1.700. Meanwhile, setting the lower limit of the conditional expression (4-1) at 1.672 can make the effects of the present embodiment more achievable. To make the effects of the present embodiment further achievable, the lower limit of the conditional expression (4-1) may be set at 1.675, 1.678, or even 1.680.

In the optical system of Embodiment 1, the specific lens may satisfy the following conditional expression (2-2).

36.0<νdLZ<38.2 (2-2)

The conditional expression (2-2) is similar to the conditional expression (2). With the conditional expression (2-2) satisfied, correction of reference aberrations such as a spherical aberration and a coma aberration and correction of a primary chromatic aberration (achromatization) can be successfully performed. Setting the upper limit of the conditional expression (2-2) at 38.1 can make the effects of the present embodiment more achievable. To make the effects of the present embodiment further achievable, the upper limit of the conditional expression (2-2) may be set at 38.0, 37.9, or even 37.8. Meanwhile, setting the lower limit of the conditional expression (2-2) at 36.1 can make the effects of the present embodiment more achievable. To make the effects of the present embodiment further achievable, the lower limit of the conditional expression (2-2) may be set at 36.2, 36.3, or even 36.4.

In the optical system of Embodiment 1, it is desirable that the specific lens be a negative lens. This makes it possible to successfully correct various aberrations such as a coma aberration and a chromatic aberration (an longitudinal chromatic aberration and a chromatic aberration of magnification).

It is desirable that the optical system of Embodiment 1 comprise a lens group movable along the optical axis upon focusing and the specific lens be included in the lens group. This makes it possible to successfully correct various aberrations such as a coma aberration and a chromatic aberration (an longitudinal chromatic aberration and a chromatic aberration of magnification).

In the optical system of Embodiment 1, it is desirable that the specific lens be a glass lens. This makes it possible to obtain a lens tolerant of aged deterioration and tolerant of environmental changes such as a temperature change as compared with in a case where the material includes a resin.

It is desirable that the optical system of Embodiment 1 comprise an aperture stop and the specific lens be disposed in the neighborhood of the aperture stop. This makes it possible to successfully correct various aberrations such as a coma aberration and a chromatic aberration (an longitudinal chromatic aberration and a chromatic aberration of magnification).

In the optical system of Embodiment 1, it is desirable that the specific lens be a lens constituting a cemented lens. This makes it possible to successfully correct various aberrations such as a coma aberration and a chromatic aberration (an longitudinal chromatic aberration and a chromatic aberration of magnification).

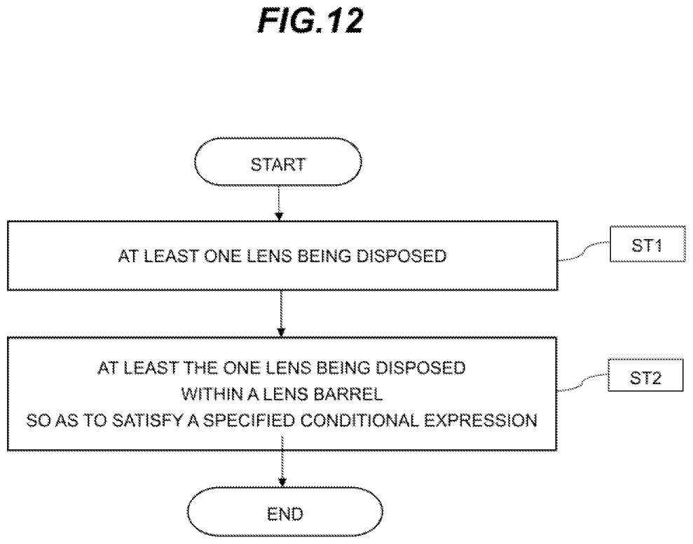

Subsequently, a manufacturing method of the optical system LS according to Embodiment 1 will be outlined with reference to FIG. 12. First, at least one lens is disposed (Step ST1). In this regard, at least the one lens is disposed within a lens barrel such that at least one (specific lens) of at least the one lens satisfies the above-described conditional expression (1), conditional expression (2), etc. (Step ST2). Such a manufacturing method enables manufacturing an optical system with a secondary spectrum successfully corrected in addition to primary achromatization during chromatic aberration correction.

Next, description will be made on Embodiment 2 of the optical system (photographic lens). The optical system according to Embodiment 2, which is similar in configuration to the optical system LS according to Embodiment 1, will be described with use of the same reference signs as in Embodiment 1. It is desirable that the optical system LS(1), which is an example of the optical system LS according to Embodiment 2, comprise a lens (L22) satisfying the following conditional expression (5) and conditional expression (2) as shown in FIG. 1. In Embodiment 2, the lens satisfying the conditional expression (5) and the conditional expression (2) is occasionally referred to as a specific lens for the purpose of distinguishing from another lens.

1.8500<ndLZ+(0.00495×νdLZ)<1.9200 (5)

28.0<νdLZ<40.0 (2)

where, ndLZ: the refractive index of the specific lens relative to a d-line

νdLZ: the d-line based Abbe number of the specific lens

According to Embodiment 2, it is possible to provide an optical system with a secondary spectrum successfully corrected in addition to primary achromatization during chromatic aberration correction and an optical apparatus comprising the optical system. The optical system LS according to Embodiment 2 may be the optical system LS(2) shown in FIG. 3, the optical system LS(3) shown in FIG. 5, or the optical system LS(4) shown in FIG. 8.

The conditional expression (5) defines an appropriate relation between the refractive index of a material of the specific lens and the Abbe number. With the conditional expression (5) satisfied, correction of reference aberrations such as a spherical aberration and a coma aberration and correction of a primary chromatic aberration (achromatization) can be successfully performed.

An increase in the corresponding value of the conditional expression (5) above the upper limit is not preferable, since it makes the curvature of field difficult to correct due to, for example, a reduction in the Petzval sum. Setting the upper limit of the conditional expression (5) at 1.9150 can make the effects of the present embodiment more achievable. To make the effects of the present embodiment further achievable, the upper limit of the conditional expression (5) may be set at 1.9100, 1.9050, 1.9010, or even 1.8990.

A decrease in the corresponding value of the conditional expression (5) below the lower limit is not preferable, since it makes correction of various aberrations including an longitudinal chromatic aberration difficult. Setting the lower limit of the conditional expression (5) at 1.8550 can make the effects of the present embodiment more achievable. To make the effects of the present embodiment further achievable, the lower limit of the conditional expression (5) may be set at 1.8600, 1.8650, 1.8675, or even 1.8690.

The conditional expression (2) is the same as the conditional expression (2) in Embodiment 1. With the conditional expression (2) satisfied, correction of reference aberrations such as a spherical aberration and a coma aberration and correction of a primary chromatic aberration (achromatization) can be successfully performed as in Embodiment 1. Setting the upper limit of the conditional expression (2) at 39.5 can make the effects of the present embodiment more achievable. To make the effects of the present embodiment further achievable, the upper limit of the conditional expression (2) may be set at 39.0 or even 38.5. Setting the lower limit of the conditional expression (2) at 28.5 can make the effects of the present embodiment more achievable. To make the effects of the present embodiment further achievable, the lower limit of the conditional expression (2) may be set at 29.0 or even 29.5.

In the optical system of Embodiment 2, it is desirable that the specific lens satisfy the above-described conditional expression (3) or conditional expression (4) as in Embodiment 1. Further, the specific lens may satisfy the above-described conditional expression (4-1), conditional expression (2-1), or conditional expression (2-2) as in Embodiment 1. Further, it is desirable that the specific lens be a negative lens as in Embodiment 1. It is desirable that the specific lens be included in the lens group movable along the optical axis upon focusing. It is desirable that the specific lens be a glass lens. It is desirable that the specific lens be disposed in the neighborhood of the aperture stop. It is desirable that the specific lens be a lens constituting a cemented lens.

Subsequently, a manufacturing method of the optical system LS according to Embodiment 2 will be outlined. The manufacturing method of the optical system LS according to Embodiment 2, which is similar to the manufacturing method described in Embodiment 1, will be described with referenced to the same figure, FIG. 12, as in Embodiment 1. First, at least one lens is disposed (Step ST1). In this regard, at least the one lens is disposed within a lens barrel such that at least one (specific lens) of at least the one lens satisfies the above-described conditional expression (5), conditional expression (2), etc. (Step ST2). Such a manufacturing method enables manufacturing an optical system with a secondary spectrum successfully corrected in addition to primary achromatization during chromatic aberration correction.

### EXAMPLES

Description will be made on the optical systems LS according to the examples of Embodiment 1 and Embodiment 2 with reference to the drawings. FIG. 1, FIG. 3, FIG. 5, and FIG. 8 are cross sectional views of the respective configurations and refractive power distributions of the optical systems LS {LS(1) to LS(4)} according to Example 1 to Example 4. In the cross sectional views of the optical systems LS(1) to LS(4) according to Example 1 to Example 4, the direction of the movement of focusing lens groups upon focusing on a short-distance object from an infinite-distance object is shown by an arrow with the characters “Focusing”. In the cross sectional views of the optical systems LS(3) and LS(4) according to Example 3 and Example 4, the direction of the movement of the lens groups along the optical axis upon zooming from a wide-angle end state (W) to a telephoto end state (T) is shown by an arrow.

In FIG. 1, FIG. 3, FIG. 5, and FIG. 8, the lens groups are each denoted by a combination of a reference sign G and a numeric character and the lenses are each denoted by a combination of a reference sign L and a numeric character. In this case, to prevent the variety and number of reference signs and numeric characters from being increased to be complicated, the lens groups, etc. are denoted with use of combinations of reference signs and numeric characters independently in each example. Accordingly, even though the combinations of reference signs and numeric characters used are the same among the examples, it does not mean that the configurations are the same.

Out of Table 1 to Table 4 shown below, Table 1 shows data regarding Example 1, Table 2 shows data regarding Example 2, Table 3 shows data regarding Example 3, and Table 4 shows data regarding Example 4. In each example, a d-line (wavelength λ=587.6 nm) and a g-line (wavelength λ=435.8 nm) are selected as calculation targets for aberration characteristics.

In the table of [General Data], f denotes the focal length of the whole zoom lens, FNO denotes an F number, 2a denotes an angle of view (the unit is ° (degree) and a denotes a half angle of view), and Y denotes an image height. TL denotes a distance given by adding BF to a distance from a lens forefront surface to a lens last surface on the optical axis upon focusing on infinity and BF denotes a distance (backfocus) from the lens last surface to the image surface I on the optical axis upon focusing on infinity. It should be noted that in a case where the optical system is a zoom optical system, these values given upon zooming in each of zooming states such as the wide-angle end state (W), an intermediate focal length (M), and the telephoto end state (T) are shown.

In the table of [Lens Data], a surface number indicates an order of optical surfaces from an object side along a direction for a light ray to travel, R denotes the radius of curvature (a surface with a center of curvature located on an image side is given a positive value) of each optical surface, D denotes a distance to the next lens surface, that is, a distance from each optical surface to the next optical surface (or an image surface) on the optical axis, nd denotes the refractive index of a material of an optical member relative to a d-line, νd denotes the d-line based Abbe number of the material of the optical member, and θgF denotes a partial dispersion ratio of the material of the optical member. “cc” for the radius of curvature denotes a flat surface or an aperture and (aperture stop S) denotes the aperture stop S. The refractive index of air nd=1.00000 is omitted. In a case where an optical surface is an aspherical surface, * is attached to the surface number thereof and a paraxial radius of curvature is shown in a column of the radius of curvature R.

ng denotes the refractive index of the material of the optical member relative to a g-line (wavelength λ=435.8 nm), nF denotes the refractive index of the material of the optical member relative to an F-line (wavelength λ=486.1 nm), and nC denotes the refractive index of the material of the optical member relative to a C-line (wavelength λ=656.3 nm). In this case, the partial dispersion ratio θgF of the material of the optical member is defined by the following expression (A).

θgF=(ng−nF)/(nF−nC) (A)

In a table of [Aspherical Surface Data], the shape of the aspherical surface indicated in [Lens Data] is represented by the following expression(B). X(y) denotes a distance (sag amount) along the optical axis direction from a tangent plane at the vertex of the aspherical surface to a position on the aspherical surface at a height y, R denotes the radius of curvature (paraxial radius of curvature) of a reference spherical surface, κ denotes a conical coefficient, and Ai denotes an aspherical coefficient of the i-th order. “E-n” denotes “×10⁻ⁿ”. For example, 1.234E-05=1.234×10⁻⁵. It should be noted that an aspherical coefficient A2 of the second order, which is zero, is omitted.

X(y)=(y²/R)/{1+(1−κ×y²/R²)^{1/2}}+A4×y⁴+A6×y⁶+A8×y⁸+A10×y¹⁰ (B)

In a case where the optical system is not a zoom optical system, in [Variable Distance Data on Short-Distance Photographing], f denotes the focal length of the whole zoom lens and denotes photographing magnification. Further, a table of [Variable Distance Data on Short-Distance Photographing] shows a distance to the next lens surface corresponding to each of the focal length and photographing magnification at a surface number that is “Variable” in terms of distance to the next lens surface according to [Lens Data].

In a case where the optical system is a zoom optical system a distance to the next lens surface corresponding to each of zooming states such as the wide-angle end state (W), the intermediate focal length (M), and the telephoto end state (T) at a surface number that is “Variable” in terms of distance to the next lens surface according to [Lens Data] is shown as [Variable Distance Data on Zoom Photographing].

A table of [Lens Group Data] shows the first surface (the surface nearest to an object) and the focal length of each lens group.

A table of [Conditional Expression Corresponding Value] shows a value corresponding to each conditional expression.

Hereinafter, regarding all the data values, “mm” is used for the focal length f, the radius of curvature R, the distance to the next lens surface D, any other length, etc. listed unless specified otherwise, but it is not limitative, since an optical system can exhibit an equivalent optical performance even when proportionally scaled.

The explanation given above is common to all the examples and the redundant explanation is omitted hereinbelow.

### Example 1

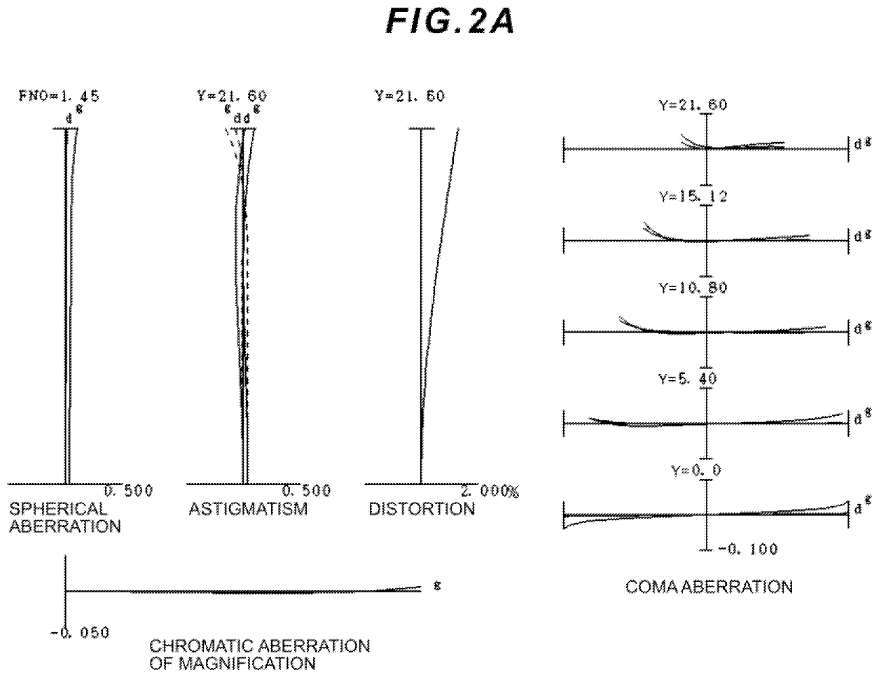

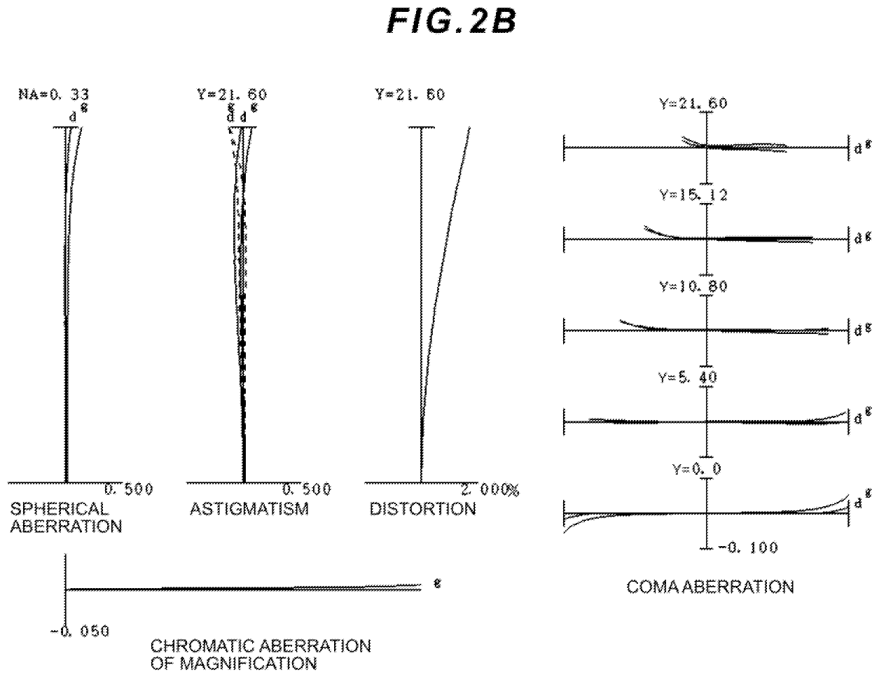

Description will be made on Example 1 with reference to FIG. 1, FIG. 2A, FIG. 2B, and Table 1. FIG. 1 shows a lens configuration of the optical system according to Example 1 for Embodiment 1 and Embodiment 2 upon focusing on infinity. The optical system LS(1) according to Example 1 comprises, in order from an object, a first lens group G1 disposed on an object side relative to the aperture stop S and exhibiting a positive refractive power and a second lens group G2 disposed on an image side relative to the aperture stop S and exhibiting a positive refractive power. The aperture stop S is situated between the first lens group G1 and the second lens group G2. A reference sign (+) or (−) attached to each lens group sign denotes the refractive power of each lens group, which applies to all the examples hereinbelow.

The first lens group G1 comprises, in order from the object, a positive meniscus lens L11 having a convex surface facing the object, a biconvex positive lens L12, a cemented lens consisting of a biconvex positive lens L13 and a biconcave negative lens L14, a cemented lens consisting of a positive meniscus lens L15 having a concave surface facing the object and a biconcave negative lens L16, a biconvex positive lens L17, and a cemented lens consisting of a biconvex positive lens L18 and a biconcave negative lens L19. In the present example, upon focusing from an infinite-distance object onto a short-distance (finite-distance) object, the cemented lens consisting of the positive meniscus lens L15 and the negative lens L16 of the first lens group G1 is moved toward the image along the optical axis.

The second lens group G2 comprises, in order from the object, a biconvex positive lens L21, a cemented lens consisting of a biconcave negative lens L22 and a positive meniscus lens L23 having a convex surface facing the object, and a cemented lens consisting of a biconcave negative lens L24 and a biconvex positive lens L25. In the present example, the negative lens L22 of the second lens group G2 corresponds to a lens (specific lens) satisfying the conditional expression (1), the conditional expression (2), the conditional expression (5), etc. The image surface I is disposed on the image side of the second lens group G2.

Table 1 below shows values of data regarding the optical system according to Example 1.

TABLE 1
[General Data]

| | |
|---|---|
| f | 104.24 |
| FNO | 1.45 |
| 2ω | 23.16 |
| Y | 21.60 |
| TL | 149.38 |
| BF | 38.34 |

[Lens Data]

| Surface | | | | | |
|---|---|---|---|---|---|
| Number | R | D | nd | νd | θgF |
| Object | ∞ | | | | |
| Surface | | | | | |
| 1 | 172.7424 | 6.000 | 1.59349 | 67.00 | |
| 2 | 10105.0317 | 0.100 | | | |
| 3 | 96.7991 | 9.232 | 1.49782 | 82.57 | |
| 4 | −1180.8161 | 0.100 | | | |
| 5 | 70.5943 | 12.063 | 1.49782 | 82.57 | |
| 6 | −234.2345 | 3.500 | 1.72047 | 34.71 | |
| 7 | 148.1591 | D7 | | | |
| | | (Variable) | | | |
| 8 | −151.5596 | 4.000 | 1.65940 | 26.87 | |
| 9 | −80.0677 | 2.500 | 1.48749 | 70.32 | |
| 10 | 46.2188 | D10 | | | |
| | | (Variable) | | | |
| 11 | 66.4365 | 7.132 | 2.00100 | 29.13 | |
| 12 | −263.8864 | 0.100 | | | |
| 13 | 212.2900 | 7.650 | 1.69680 | 55.52 | |
| 14 | −50.0085 | 1.800 | 1.72825 | 28.38 | |
| 15 | 30.5602 | 5.900 | | | |
| 16 | ∞ | 1.600 | | | (Aperture |
| | | | | | Stop S) |
| 17 | 88.4778 | 5.183 | 1.59319 | 67.90 | |
| 18 | −95.3813 | 1.184 | | | |
| 19 | −54.1274 | 1.600 | 1.68376 | 37.58 | 0.5782 |
| 20 | 30.8859 | 7.378 | 1.79952 | 42.09 | |
| 21 | 219.4156 | 1.710 | | | |
| 22 | −143.5827 | 1.800 | 1.65940 | 26.87 | |
| 23 | 103.8017 | 5.209 | 2.00100 | 29.13 | |
| 24 | −65.2550 | BF | | | |
| Image | ∞ | | | | |
| Surface | | | | | |

[Variable distance data on short-distance photographing]

| | | Upon focusing |
|---|---|---|
| | Upon focusing | on a short-distance |
| | on infinity | object |
| | f = 104.24 | β = 1/30 |
| D7 | 8.703 | 11.581 |
| D10 | 16.596 | 13.719 |

[Lens Group Data]

| | First | Focal |
|---|---|---|
| Group | surface | length |
| G1 | 1 | 255.964 |
| G2 | 17 | 70.804 |

[Conditional Expression Corresponding Value]
Conditional Expression (1)
ndLZ + (0.00925 × νdLZ) = 2.0314
Conditional Expression (2), (2-1), (2-2)
νdLZ = 37.58
Conditional Expression (3)
θgFLZ + (0.00316 × νdLZ) = 0.6970
Conditional Expression (4), (4-1)
ndLZ = 1.68376
Conditional Expression (5)
ndLZ + (0.00495 × νdLZ) = 1.8698

FIG. 2A is graphs showing various aberrations of the optical system according to Example 1 upon focusing on infinity. FIG. 2B is graphs showing various aberrations of the optical system according to Example 1 upon focusing on a short-distance (close-distance) object. In each of the graphs showing aberrations upon focusing on infinity, FNO denotes an F number and Y denotes an image height. In each of the graphs showing aberrations upon focusing on a short-distance object, NA denotes a numerical aperture, and Y denotes an image height. It should be noted that a spherical aberration graph shows an F number corresponding to a maximum aperture diameter or a numerical aperture, an astigmatism graph and a distortion graph each show the maximum value of the image height, and a coma aberration graph shows the value of each image height. d denotes a d-line (wavelength λ=587.6 nm) and g denotes a g-line (wavelength λ=435.8 nm). In the astigmatism graph, a solid line represents a sagittal image surface and a dashed line represents a meridional image surface. It should be noted that the same reference signs as in the present example are used in aberration graphs of examples described hereinbelow and the redundant explanation is omitted.

It is found from the graphs showing various aberrations that the optical system according to Example 1 exhibits an excellent image forming performance with the various aberrations successfully corrected.

### Example 2

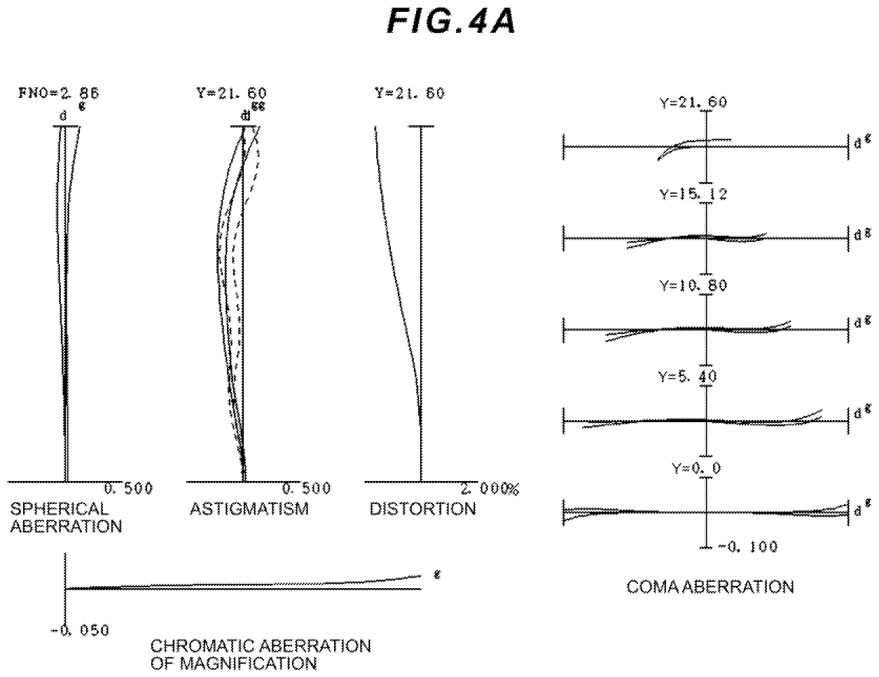

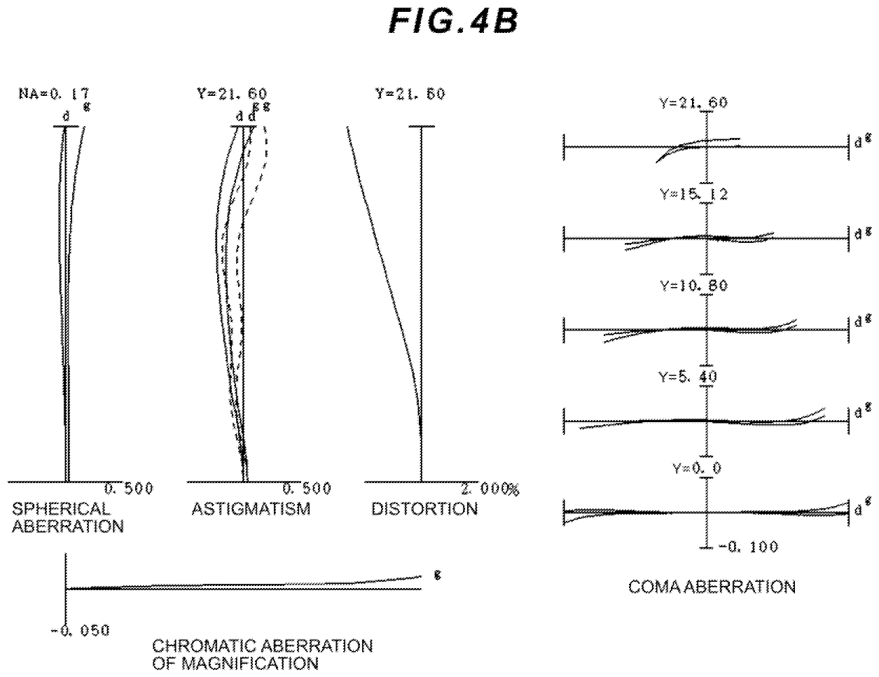

Description will be made on Example 2 with reference to FIG. 3, FIG. 4A, FIG. 4B, and Table 2. FIG. 3 shows a lens configuration of an optical system according to Example 2 of Embodiment 1 and Embodiment 2 upon focusing on infinity. The optical system LS(2) according to Example 2 comprises, in order from an object, a first lens group G1 disposed on an object side relative to the aperture stop S and exhibiting a positive refractive power and a second lens group G2 disposed on an image side relative to the aperture stop S and exhibiting a positive refractive power. The aperture stop S is situated between the first lens group G1 and the second lens group G2.

The first lens group G1 comprises, in an order from the object, a negative meniscus lens L11 having a convex surface facing the object, a negative meniscus lens L12 having a convex surface facing the object, a cemented lens consisting of a biconvex positive lens L13 and a biconcave negative lens L14, a positive meniscus lens L15 having a convex surface facing the object, and a cemented lens consisting of a negative meniscus lens L16 having a convex surface facing the object and a biconvex positive lens L17. The image-side lens surface of the negative meniscus lens L12 is an aspherical surface. In the present example, the negative meniscus lens L16 of the first lens group G1 corresponds to a lens (specific lens) satisfying the conditional expression (1), the conditional expression (2), the conditional expression (5), etc. The cemented lens consisting of the negative meniscus lens L16 and the positive lens L17 of the first lens group G1 constitutes a vibration-proof lens group (partial group) movable in a direction perpendicular to the optical axis, correcting a displacement of an imaging position (an image blur on the image surface I) due to camera shake or the like.

The second lens group G2 comprises, in order from the object, a negative meniscus lens L21 having a concave surface facing the object, a biconvex positive lens L22, and a positive meniscus lens L23 having a concave surface facing the object. The image surface I is disposed on the image side of the second lens group G2. The object-side lens surface of the positive meniscus lens L23 is an aspherical surface. In the present example, upon focusing from an infinite-distance object onto a short-distance (finite-distance) object, the whole of the second lens group G2 moves toward the object along the optical axis.

Table 2 below shows values of data regarding the optical system according to Example 2.

TABLE 2
[General Data]

| | |
|---|---|
| f | 20.60 |
| FNO | 2.86 |
| 2ω | 93.64 |
| Y | 21.60 |
| TL | 106.76 |
| BF | 38.959 |

[Lens Data]

| Surface | | | | | |
|---|---|---|---|---|---|
| Number | R | D | nd | νd | θgF |
| Object | ∞ | | | | |
| Surface | | | | | |
| 1 | 35.3881 | 1.400 | 1.69680 | 55.52 | |
| 2 | 15.8481 | 6.847 | | | |
| 3 | 23.1939 | 1.400 | 1.60311 | 60.69 | |
| 4* | 11.5711 | 7.796 | | | |
| 5 | 75.5455 | 5.704 | 1.60342 | 38.03 | |
| 6 | −29.3767 | 1.400 | 1.69680 | 55.52 | |
| 7 | 191.0345 | 4.167 | | | |
| 8 | 26.9558 | 4.929 | 1.74950 | 35.25 | |
| 9 | 73.8090 | 4.744 | | | |
| 10 | 37.9905 | 1.400 | 1.68376 | 37.58 | 0.5782 |
| 11 | 14.9053 | 4.287 | 1.51860 | 69.89 | |
| 12 | −50.9569 | 5.000 | | | |
| 13 | ∞ | D13 | | | (Aperture |
| | | (Variable) | | | Stop S) |
| 14 | −18.8348 | 1.500 | 1.72825 | 28.38 | |
| 15 | −104.4518 | 0.150 | | | |
| 16 | 78.8823 | 5.137 | 1.59319 | 67.90 | |
| 17 | −20.2060 | 0.220 | | | |
| 18* | −81.8607 | 0.150 | 1.51380 | 52.90 | |
| 19 | −51.5576 | 2.335 | 1.60311 | 60.69 | |
| 20 | -34.5733 | BF | | | |
| Image | ∞ | | | | |
| Surface | | | | | |

[Aspherical Surface Data]
4th Surface
κ = −1.7615
A4 = 1.59119E−04, A6 = −7.22596E−07, A8 = 2.86248E−09,
A10 = −7.75694E−12
18th Surface
κ1.0000
A4 = −2.85329E−05, A6 = −4.17411E−08,
A8 = −1.26145E−10, A10 = 0.00000E+00
[Variable distance data on short-distance photographing]

| | | Upon focusing |
|---|---|---|
| | Upon focusing | on a short-distance |
| | on infinity | object |
| | f = 20.60 | β = 1/30 |
| D13 | 9.234 | 8.456 |
| BF | 38.959 | 39.737 |

[Lens Group Data]

| | First | Focal |
|---|---|---|
| Group | surface | length |
| G1 | 1 | 58.839 |
| G2 | 14 | 51.129 |

[Conditional Expression Corresponding Value]
Conditional Expression (1)
ndLZ + (0.00925 × νdLZ) = 2.0314
Conditional Expression (2), (2-1), (2-2)
νdLZ = 37.58
Conditional Expression (3)
θgFLZ + (0.00316 × νdLZ) = 0.6970
Conditional Expression (4), (4-1)
ndLZ = 1.68376
Conditional Expression (5)
ndLZ + (0.00495 × νdLZ) = 1.8698

FIG. 4A is graphs showing various aberrations of the optical system according to Example 2 upon focusing on infinity. FIG. 4B is graphs showing various aberrations of the optical system according to Example 2 upon focusing on a short-distance (close-distance) object. It is found from the graphs showing various aberrations that the optical system according to Example 2 exhibits an excellent image forming performance with the various aberrations successfully corrected.

### Example 3

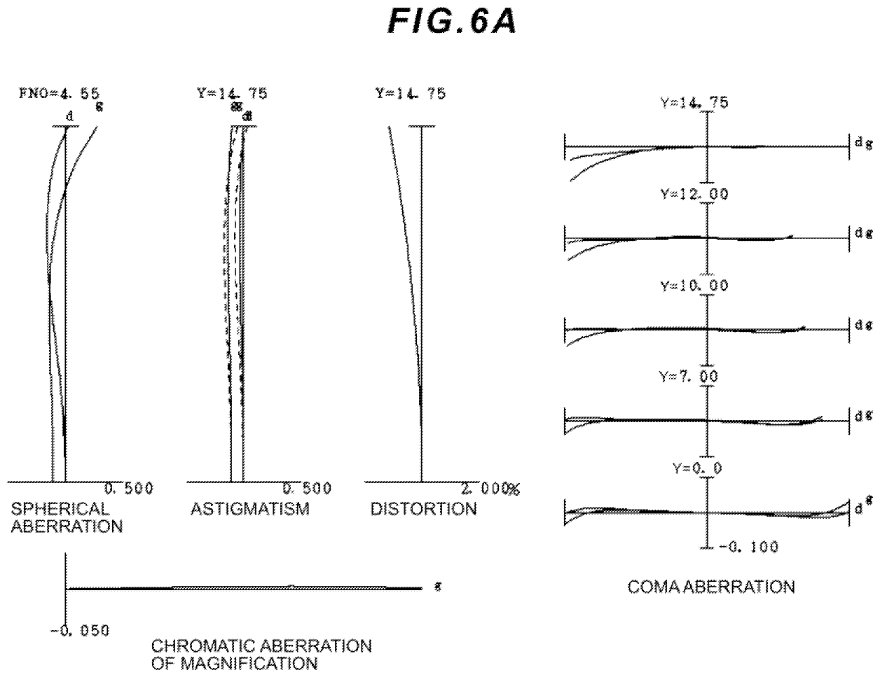

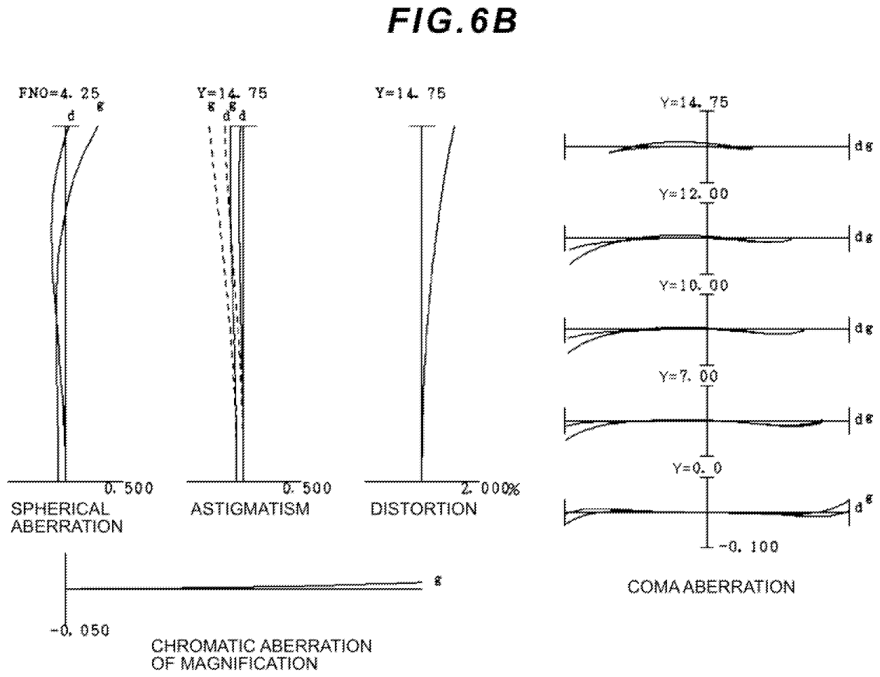

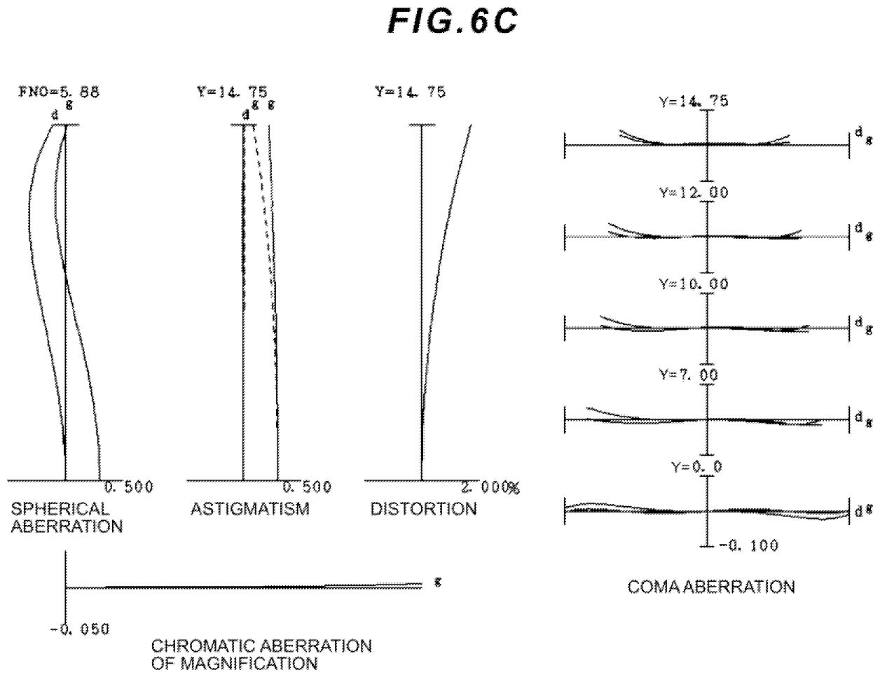

Description will be made on Example 3 with reference to FIG. 5, FIGS. 6A to 6C, and Table 3. FIG. 5 shows a lens configuration of an optical system according to Example 3 of Embodiment 1 and Embodiment 2 upon focusing on infinity. The optical system LS(3) according to Example 3 comprises, in order from the object, a first lens group G1 exhibiting a positive refractive power, a second lens group G2 exhibiting a negative refractive power, and a third lens group G3 exhibiting a positive refractive power. Upon zooming from the wide-angle end state (W) to the telephoto end state (T), the first to third lens groups G1 to G3 are moved in respective directions shown by arrows in FIG. 5. The aperture stop S is situated within the third lens group G3.

The first lens group G1 comprises, in order from the object, a biconvex positive lens L11 and a cemented lens consisting of a negative meniscus lens L12 having a convex surface facing the object and a positive meniscus lens L13 having a convex surface facing the object.

The second lens group G2 comprises, in order from the object, a cemented lens consisting of a biconcave negative lens L21 and a positive meniscus lens L22 having a convex surface facing the object and a biconcave negative lens L23.

The third lens group G3 comprises, in order from the object, a biconvex positive lens L31, a cemented lens consisting of a biconvex positive lens L32 and a biconcave negative lens L33, a cemented lens consisting of a negative meniscus lens L34 having a convex surface facing the object and a biconvex positive lens L35, a positive meniscus lens L36 having a convex surface facing the object, a cemented lens consisting of a positive meniscus lens L37 having a concave surface facing the object and a biconcave negative lens L38, and a biconvex positive lens L39. The image surface I is disposed on the image side of the third lens group G3. The aperture stop S is disposed between the positive lens L31 and the positive lens L32 (of the cemented lens) of the third lens group G3. In the present example, the positive meniscus lens L37 of the third lens group G3 corresponds to a lens satisfying the conditional expression (1), the conditional expression (2), the conditional expression (5), etc. Upon focusing from an infinite-distance object onto a short-distance (finite-distance) object, the cemented lens consisting of the positive meniscus lens L37 and the negative lens L38 of the third lens group G3 is moved toward the image along the optical axis.

Table 3 below shows values of data regarding the optical system according to Example 3.

TABLE 3
[General Data]
Zooming ratio 4.12

| | W | M | T |
|---|---|---|---|
| f | 71.4 | 100.0 | 294.0 |
| FNO | 4.55 | 4.25 | 5.88 |
| 2ω | 23.60 | 16.60 | 5.65 |
| Y | 14.75 | 14.75 | 14.75 |
| TL | 159.81 | 185.81 | 220.18 |
| BF | 45.42 | 39.59 | 70.55 |

[Lens Data]

| Surface | | | | | |
|---|---|---|---|---|---|
| Number | | | | | |
| Object | R | | | | |
| Surface | ∞ | D | nd | νd | θgF |
| 1 | 91.5192 | 6.167 | 1.51680 | 63.88 | |
| 2 | −891.1989 | 0.204 | | | |
| 3 | 93.2278 | 1.500 | 1.64769 | 33.73 | |
| 4 | 46.6019 | 7.000 | 1.48749 | 70.31 | |
| 5 | 154.0927 | D5 (Variable) | | | |
| 6 | −213.5954 | 1.000 | 1.69680 | 55.52 | |
| 7 | 22.9724 | 3.677 | 1.80518 | 25.45 | |
| 8 | 60.5666 | 2.652 | | | |
| 9 | −47.0346 | 1.000 | 1.77250 | 49.62 | |
| 10 | 299.7358 | D10 (Variable) | | | |
| 11 | 48.1577 | 3.796 | 1.69680 | 55.52 | |
| 12 | −129.8462 | 1.000 | | | |
| 13 | ∞ | 1.000 | | | (Aperture |
| | | | | | Stop S) |
| 14 | 38.7747 | 4.932 | 1.69680 | 55.52 | |
| 15 | −51.1476 | 1.000 | 1.85026 | 32.35 | |
| 16 | 67.2884 | 8.805 | | | |
| 17 | 57.5054 | 1.000 | 1.80100 | 34.92 | |
| 18 | 17.5096 | 6.038 | 1.48749 | 70.31 | |
| 19 | −137.4937 | 0.200 | | | |
| 20 | 26.2266 | 3.513 | 1.59270 | 35.27 | |
| 21 | 96.5593 | D21 (Variable) | | | |
| 22 | −139.1808 | 3.510 | 1.68376 | 37.58 | 0.5782 |
| 23 | −15.9128 | 1.000 | 1.64000 | 60.20 | |
| 24 | 25.6230 | D24 (Variable) | | | |
| 25 | 145.8454 | 2.143 | 1.48749 | 70.31 | |
| 26 | −480.8453 | BF | | | |
| Image | ∞ | | | | |
| Surface | | | | | |

[Variable distance data on zoom photographing]

| | | | | W | M | T |
|---|---|---|---|---|---|---|
| | W | M | T | Short- | Short- | Short- |
| | Infinity | Infinity | Infinity | distance | distance | distance |
| D5 | 2.881 | 37.560 | 65.654 | 2.881 | 37.560 | 65.654 |
| D10 | 29.543 | 26.683 | 2.000 | 29.543 | 26.683 | 2.000 |
| D21 | 5.002 | 5.002 | 5.002 | 5.340 | 5.540 | 5.891 |
| D24 | 15.836 | 15.836 | 15.836 | 15.498 | 15.298 | 14.947 |

[Lens Group Data]

| | First | Focal |
|---|---|---|
| Group | surface | length |
| G1 | 1 | 147.64 |
| G2 | 6 | −31.813 |
| G3 | 11 | 38.779 |

[Conditional Expression Corresponding Value]
Conditional Expression (1)
ndLZ + (0.00925 × νdLZ) = 2.0314
Conditional Expression (2), (2-1), (2-2)
νdLZ = 37.58
Conditional Expression (3)
θgFLZ + (0.00316 × νdLZ) = 0.6970
Conditional Expression (4), (4-1)
ndLZ = 1.68376
Conditional Expression (5)
ndLZ + (0.00495 × νdLZ) = 1.8698

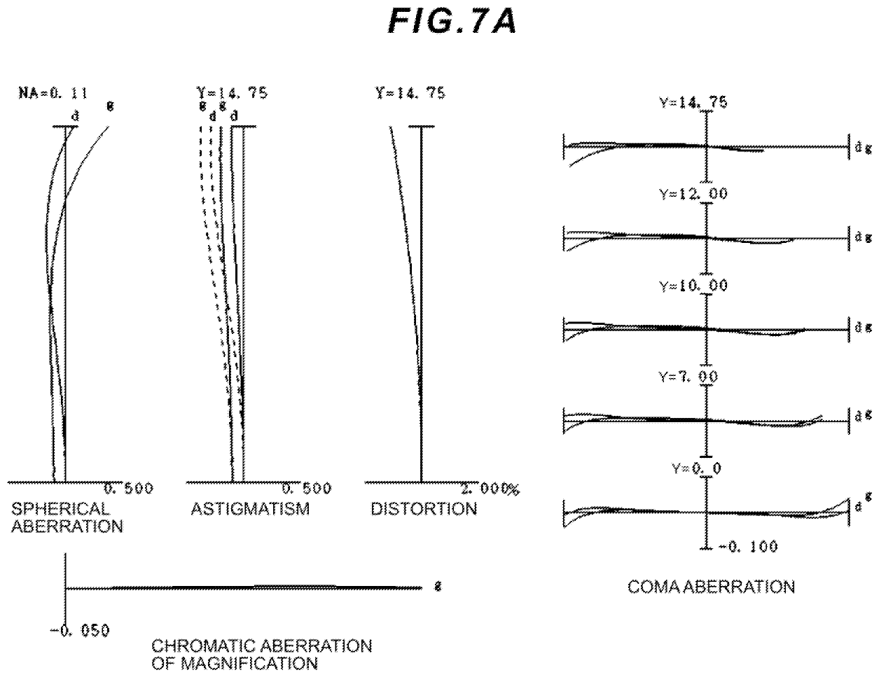

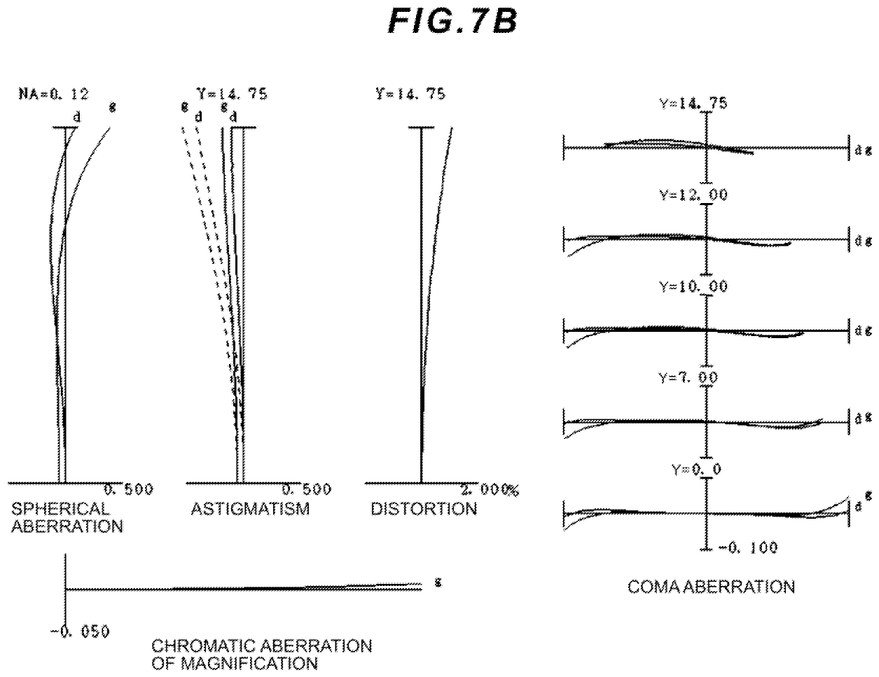

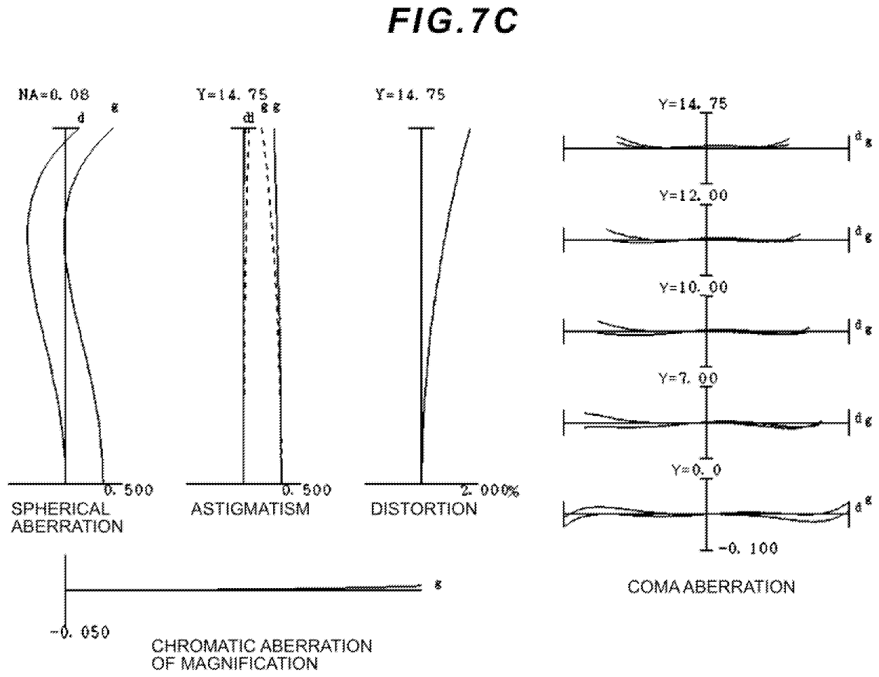

FIG. 6A, FIG. 6B, and FIG. 6C are graphs showing various aberrations of the optical system according to Example 3 upon focusing on infinity in a wide-angle end state, an intermediate focal length state, and a telephoto end state, respectively. FIG. 7A, FIG. 7B, and FIG. 7C are graphs showing various aberrations of the optical system according to Example 3 upon focusing on a short-distance object in the wide-angle end state, the intermediate focal length state, and the telephoto end state, respectively. It is found from the graphs showing various aberrations that the optical system according to Example 3 exhibits an excellent image forming performance with the various aberrations successfully corrected.

### Example 4

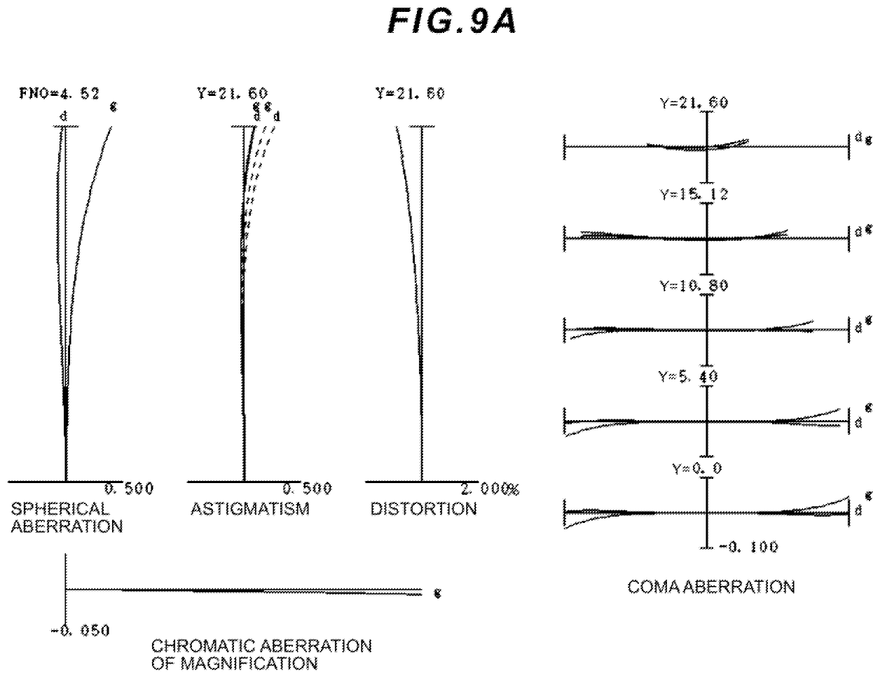

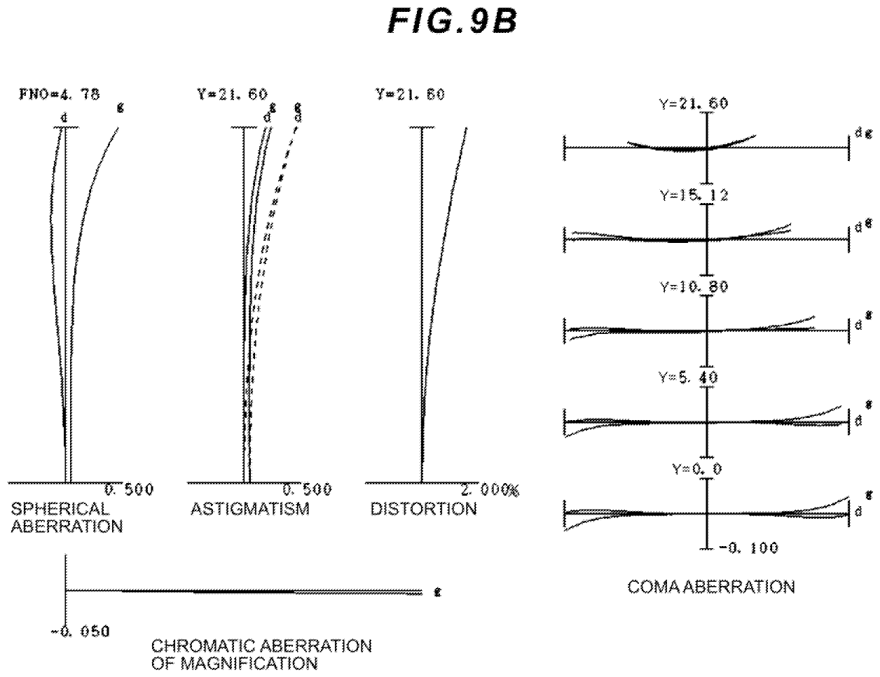

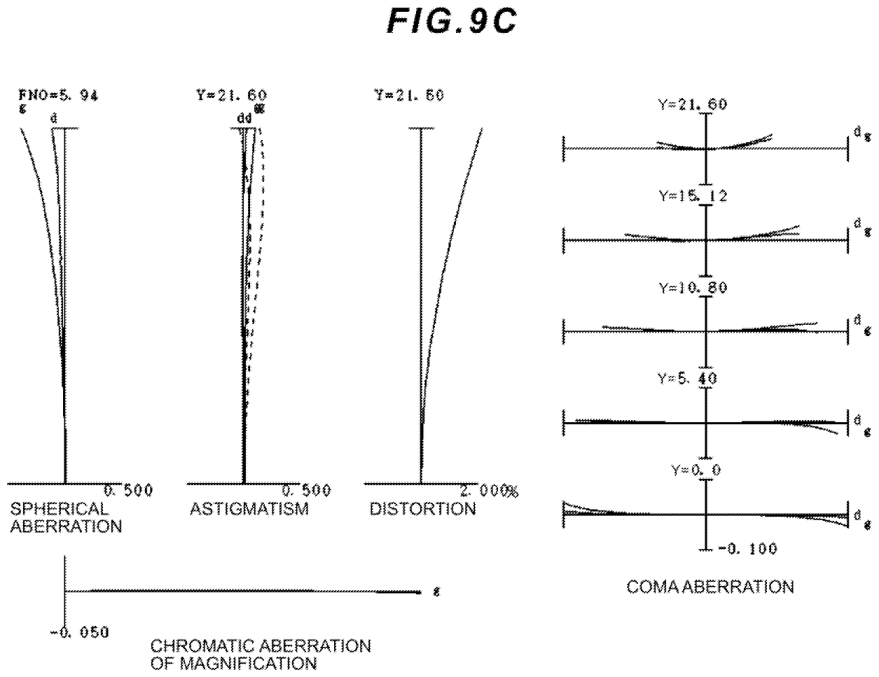

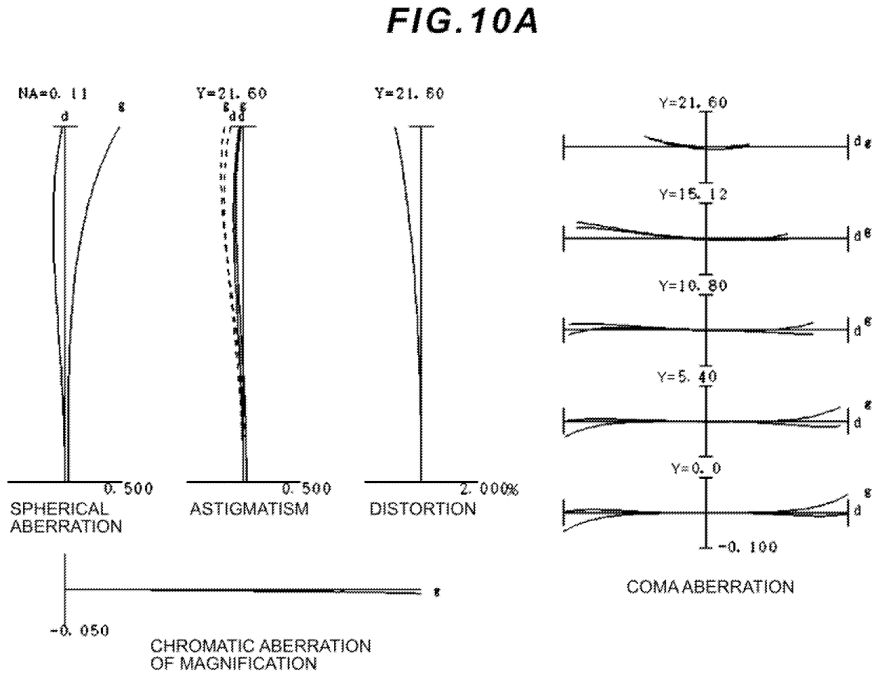

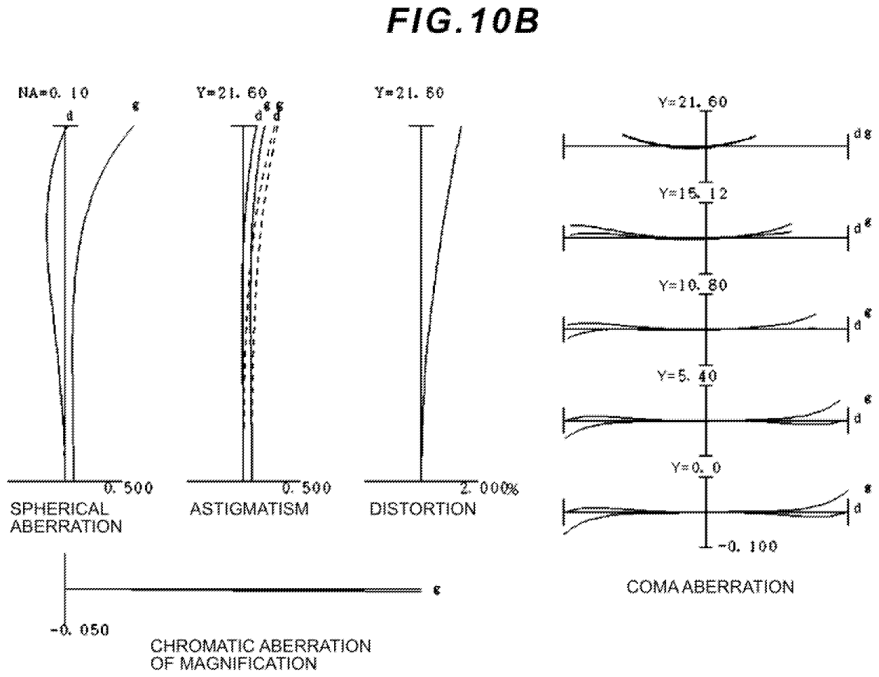

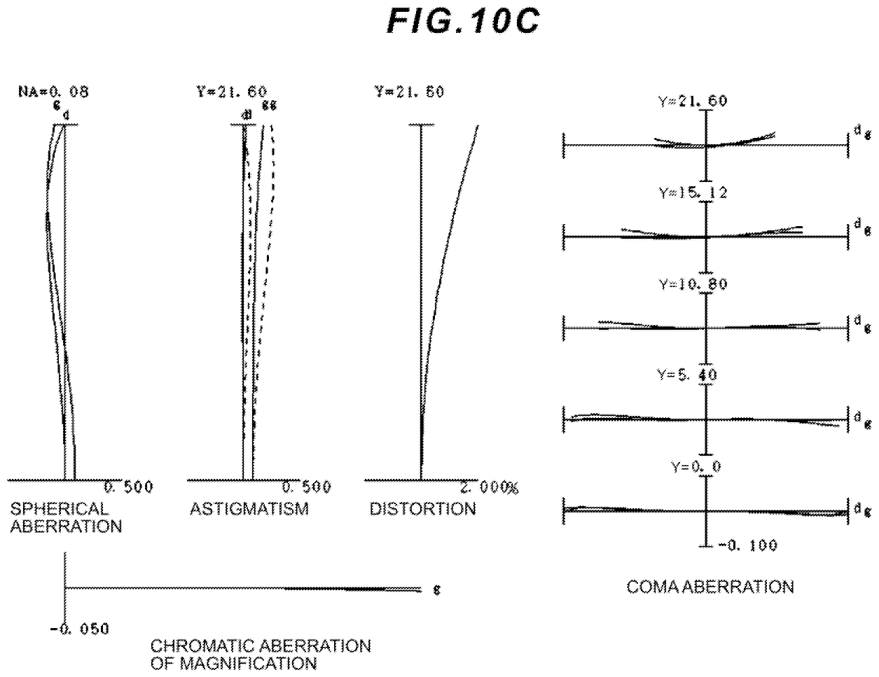

Description will be made on Example 4 with reference to FIG. 8, FIGS. 9A to 9C, FIGS. 10A, to 10C, and Table 4. FIG. 8 shows a lens configuration of an optical system according to Example 4 of Embodiment 1 and Embodiment 2 upon focusing on infinity. The optical system LS(4) according to Example 4 comprises, in order from the object, a first lens group G1 exhibiting a positive refractive power, a second lens group G2 exhibiting a negative refractive power, a third lens group G3 exhibiting a positive refractive power, a fourth lens group G4 exhibiting a positive refractive power, and a fifth lens group G5 exhibiting a negative refractive power. Upon zooming from the wide-angle end state (W) to the telephoto end state (T), the first to fifth lens groups G1 to G5 are moved in respective directions shown by arrows in FIG. 8. The aperture stop S, which is disposed in the image-side neighborhood of the third lens group G3, is moved along the optical axis together with the third lens group G3 upon zooming.

The first lens group G1 comprises, in order from the object, a biconvex positive lens L11 and a cemented lens consisting of a negative meniscus lens L12 having a convex surface facing the object and a positive meniscus lens L13 having a convex surface facing the object.

The second lens group G2 comprises, in order from the object, a negative meniscus lens L21 having a convex surface facing the object, a negative meniscus lens L22 having a concave surface facing the object, a positive meniscus lens L23 having a convex surface facing the object, and a cemented lens consisting of a biconcave negative lens L24 and a positive meniscus lens L25 having a convex surface facing the object. The cemented lens consisting of the negative lens L24 and the positive meniscus lens L25 of the second lens group G2 constitutes a vibration-proof lens group (partial group) movable in a direction perpendicular to the optical axis, correcting a displacement of an imaging position (an image blur on the image surface I) due to camera shake or the like.

The third lens group G3 comprises, in order from the object, a biconvex positive lens L31 and a cemented lens consisting of a biconvex positive lens L32 and a biconcave negative lens L33.

The fourth lens group G4 comprises a cemented lens consisting of, in order from the object, a biconvex positive lens L41 and a negative meniscus lens L42 having a concave surface facing the object. In the present example, the negative meniscus lens L42 of the fourth lens group G4 corresponds to a lens satisfying the conditional expression (1), the conditional expression (2), the conditional expression (5), etc. Upon focusing from an infinite-distance object onto a short-distance (finite-distance) object, the whole of the fourth lens group G4 moves toward the object along the optical axis.

The fifth lens group G5 comprises, in order from the object, a biconcave negative lens L51, a positive meniscus lens L52 having a concave surface facing the object, a negative meniscus lens L53 having a concave surface facing the object, and a biconvex positive lens L54. The image surface I is disposed on the image side of the fifth lens group G5.

Table 4 below shows values of data regarding the optical system according to Example 4.

TABLE 4
[General Data]
Zooming ratio 4.12

| | W | M | T |
|---|---|---|---|
| f | 71.4 | 100.0 | 294.0 |
| FNO | 4.53 | 4.79 | 5.94 |
| 2ω | 33.94 | 24.01 | 8.23 |
| Y | 21.60 | 21.60 | 21.60 |
| TL | 194.00 | 212.44 | 250.39 |
| BF | 39.00 | 43.11 | 63.39 |

[Lens Data]

| Surface | | | | | |
|---|---|---|---|---|---|
| Number | | | | | |
| Object | R | | | | |
| Surface | ∞ | D | nd | νd | θgF |
| 1 | 513.4816 | 3.6492 | 1.48749 | 70.31 | |
| 2 | −517.9588 | 0.2000 | | | |
| 3 | 98.9998 | 1.7000 | 1.67270 | 32.19 | |
| 4 | 65.9505 | 8.6798 | 1.49700 | 81.73 | |
| 5 | 1712.5853 | D5 (Variable) | | | |
| 6 | 94.8614 | 1.0000 | 1.83400 | 37.18 | |
| 7 | 34.2676 | 6.9195 | | | |
| 8 | −110.6517 | 1.0000 | 1.60300 | 65.44 | |
| 9 | −410.7751 | 0.2000 | | | |
| 10 | 45.5941 | 2.8821 | 1.84666 | 23.80 | |
| 11 | 104.9633 | 3.7758 | | | |
| 12 | −66.1701 | 1.0000 | 1.70000 | 48.11 | |
| 13 | 38.5833 | 3.4528 | 1.79504 | 28.69 | |
| 14 | 151.5709 | D14 (Variable) | | | |
| 15 | 103.7500 | 3.6986 | 1.80400 | 46.60 | |
| 16 | −80.2466 | 0.2000 | | | |
| 17 | 40.5201 | 5.1186 | 1.49782 | 82.57 | |
| 18 | −65.0491 | 1.0000 | 1.85026 | 32.35 | |
| 19 | 148.7139 | 1.5306 | | | |
| 20 | ∞ | D20 (Variable) | | | (Aperture |
| | | | | | Stop S) |
| 21 | 184.1852 | 4.4376 | 1.51680 | 63.88 | |
| 22 | −24.7956 | 1.0000 | 1.68376 | 37.58 | 0.5782 |
| 23 | −55.9883 | D23 (Variable) | | | |
| 24 | −63.6705 | 1.0000 | 1.90366 | 31.27 | |
| 25 | 109.5875 | 7.9647 | | | |
| 26 | −397.3710 | 4.4687 | 1.71736 | 29.57 | |
| 27 | −31.8750 | 16.3261 | | | |
| 28 | −22.5609 | 1.0000 | 1.80400 | 46.60 | |
| 29 | −135.0912 | 0.3428 | | | |
| 30 | 82.8523 | 3.4360 | 1.63980 | 34.55 | |
| 31 | −167.6215 | BF | | | |
| Image | ∞ | | | | |
| Surface | | | | | |

[Variable distance data on zoom photographing]

| | | | | W | M | T |
|---|---|---|---|---|---|---|
| | W | M | T | Short- | Short- | Short- |
| | Infinity | Infinity | Infinity | distance | distance | distance |
| D5 | 2.000 | 25.989 | 75.552 | 2.000 | 25.989 | 75.552 |
| D14 | 43.552 | 33.897 | 2.000 | 43.552 | 33.897 | 2.000 |
| D20 | 21.465 | 19.956 | 21.465 | 20.353 | 18.579 | 18.696 |
| D23 | 2.000 | 3.509 | 2.000 | 3.112 | 4.886 | 4.768 |

[Lens Group Data]

| | First | Focal |
|---|---|---|
| Group | surface | length |
| G1 | 1 | 173.77 |
| G2 | 6 | −42.42 |
| G3 | 15 | 50.14 |
| G4 | 21 | 120.95 |
| G5 | 24 | −57.25 |

[Conditional Expression Corresponding Value]
Conditional Expression (1)
ndLZ + (0.00925 × νdLZ) = 2.0314
Conditional Expression (2), (2-1), (2-2)
νdLZ = 37.58
Conditional Expression (3)
θgFLZ + (0.00316 × νdLZ) = 0.6970
Conditional Expression (4), (4-1)
ndLZ = 1.68376
Conditional Expression (5)
ndLZ + (0.00495 × νdLZ) = 1.8698

FIG. 9A, FIG. 9B, and FIG. 9C are graphs showing various aberrations of the optical system according to Example 4 upon focusing on infinity in the wide-angle end state, the intermediate focal length state, and the telephoto end state, respectively. FIG. 10A, FIG. 10B, and FIG. 10C are graphs showing various aberrations of the optical system according to Example 4 upon focusing on a short-distance object in the wide-angle end state, the intermediate focal length state, and the telephoto end state, respectively. It is found from the graphs showing various aberrations that the optical system according to Example 4 exhibits an excellent image forming performance with the various aberrations successfully corrected.

According to the above-described examples, it is possible to provide an optical system with a secondary spectrum successfully corrected in addition to primary achromatization during chromatic aberration correction.

Here, the above-described examples are each a specific example of the present invention and the present invention is not limited thereto.

It should be noted that the following contents can be employed if necessary as long as the optical performance of the optical system of the present embodiment is not impaired.

The focusing lens group refers to a portion comprising at least one lens spaced at an air distance variable upon focusing. That is, a single or plurality of lens groups or partial lens groups may be moved in the optical axis direction, functioning as a focusing lens group that enables focusing from an infinite-distance object onto a short-distance object. The focusing lens group, which is also usable for automatic focus, is suitable for motor driving for auto focus (with use of an ultrasonic motor or the like).

It should be noted that in Example 2, the whole of the second lens group G2 is configured to move along the optical axis upon focusing, but the present application is not limited thereto. The whole of the first lens group G1 may be configured to move along the optical axis.

In Example 2 and Example 4, the configuration with a vibration-proof function is described, but the present application is not limited thereto. A configuration with no vibration-proof function is applicable. Further, the configuration with the vibration-proof function is likewise applicable to other examples with no vibration-proof function.

The lens surface may be made as a spherical surface or a flat surface or made as an aspherical surface. In a case where the lens surface is a spherical surface or a flat surface, it is preferable because lens processing and assembly adjustment are facilitated to prevent deterioration of the optical performance due to an error in the processing and the assembly adjustment. Further, it is preferable because drawing performance is not deteriorated very much even if the image surface is displaced.

In a case where the lens surface is an aspherical surface, the aspherical surface may be any one of a ground aspherical surface, a glass-molded aspherical surface made by molding glass in the shape of an aspherical surface, and a composite type aspherical surface made by forming resin in the shape of an aspherical surface on a surface of glass. Further, the lens surface may be a diffractive surface and the lens may be a gradient index lens (GRIN lens) or a plastic lens.

To reduce flare and ghost to achieve a high-contrast optical performance, an antireflective coating exhibiting a high transmittance in a wide wavelength band may be applied to each lens surface. This makes it possible to reduce flare and ghost to achieve a high-contrast high optical performance.

### EXPLANATION OF NUMERALS AND CHARACTERS

G1: first lens group
G2: second lens group
G3: third lens group
G4: fourth lens group
G5: fifth lens group
I: image surface
S: aperture stop

1. An optical system comprising a lens satisfying the following conditional expressions:
2.0100<ndLZ+(0.00925×νdLZ)<2.0800
28.0<νdLZ<40.0
where ndLZ: a refractive index of the lens relative to a d-line, and
νdLZ: a d-line based Abbe number of the lens.

2. An optical system comprising a lens satisfying the following conditional expressions:
1.8500<ndLZ+(0.00495×νdLZ)<1.9200
28.0<νdLZ<40.0
where ndLZ: a refractive index of the lens relative to a d-line, and
νdLZ: a d-line based Abbe number of the lens.

3. The optical system according to claim 1, wherein the lens satisfies the following conditional expression:
θgFLZ+(0.00316×νdLZ)<0.7010
where θgFLZ: a partial dispersion ratio of the lens, being defined by an expression below when the refractive index of the lens relative to the g-line is denoted by ngLZ, a refractive index of the lens relative to an F-line is denoted by nFLZ, and a refractive index of the lens relative to a C-line is denoted by nCLZ,
θgFLZ=(ngLZ−nFLZ)/(nFLZ−nCLZ).

4. The optical system according to claim 1, wherein the lens satisfies the following conditional expression:
35.0<νdLZ<40.0.

5. The optical system according to claim 1, wherein the lens satisfies the following conditional expression:
1.660<ndLZ<1.750.

6. The optical system according to claim 1, wherein the lens satisfies the following conditional expression:
1.670<ndLZ<1.710.

7. The optical system according to claim 1, wherein the lens satisfies the following conditional expression:
36.0<νdLZ<38.2.

8. The optical system according to claim 1, wherein the lens is a negative lens.

9. The optical system according to claim 1, comprising a lens group movable along an optical axis upon focusing, the lens group including the lens.

10. The optical system according to claim 1, wherein the lens is a glass lens.

11. The optical system according to claim 1, further comprising an aperture stop, wherein
the lens is disposed in a neighborhood of the aperture stop.

12. The optical system according to claim 1, wherein the lens is a lens of a cemented lens.

13. An optical apparatus comprising the optical system according to claim 1.

14. A manufacturing method of an optical system including a lens, the manufacturing method comprising disposing the lens within a lens barrel such that at least one of the following sets of conditional expressions (A) or (B) is satisfied:
2.0100<ndLZ+(0.00925×νdLZ)<2.0800 Set (A)
28.0<νdLZ<40.0
where ndLZ: a refractive index of the lens relative to a d-line, and
νdLZ: a d-line based Abbe number of the lens,
1.8500<ndLZ+(0.00495×νdLZ)<1.9200 Set (B)
28.0<νdLZ<40.0
where ndLZ: a refractive index of the lens relative to a d-line, and
νdLZ: a d-line based Abbe number of the lens.

15. (canceled)

16. The optical system according to claim 2, wherein the lens satisfies the following conditional expression:
θgFLZ+(0.00316×νdLZ)<0.7010
where θgFLZ: a partial dispersion ratio of the lens, being defined by an expression below when the refractive index of the lens relative to the g-line is denoted by ngLZ, a refractive index of the lens relative to an F-line is denoted by nFLZ, and a refractive index of the lens relative to a C-line is denoted by nCLZ,
θgFLZ=(ngLZ−nFLZ)/(nFLZ−nCLZ).

17. The optical system according to claim 2, wherein the lens satisfies the following conditional expression:
35.0<νdLZ<40.0.

18. The optical system according to claim 2, wherein the lens satisfies the following conditional expression:
1.660<ndLZ<1.750.

19. The optical system according to claim 2, wherein the lens satisfies the following conditional expression:
1.670<ndLZ<1.710.

20. The optical system according to claim 2, wherein the lens satisfies the following conditional expression:
36.0<νdLZ<38.2.

21. The optical system according to claim 2, wherein the lens is a negative lens.

22. The optical system according to claim 2, comprising a lens group movable along an optical axis upon focusing, the lens group including the lens.

23. The optical system according to claim 2, wherein the lens is a glass lens.

24. The optical system according to claim 2, further comprising an aperture stop, wherein
the lens is disposed in a neighborhood of the aperture stop.

25. The optical system according to claim 2, wherein the lens is a lens of a cemented lens.

26. An optical apparatus comprising the optical system according to claim 2.
